(19) United States
(12) Patent Application Publication
(10) Pub. No.: US 2010/0225460 A1
(43) Pub. Date: Sep. 9, 2010

(54) BUMPER SENSOR

(75) Inventors: Kazuhiro Watanabe, Hachioji-shi (JP); Michiko Nishiyama, Hachioji-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TAMA-TLO, LTD., Hachioji-shi, Tokyo (JP)

(21) Appl. No.: 11/997,512

(22) PCT Filed: Apr. 28, 2006
(86) PCT No.: PCT/JP2006/309012

§ 371 Date: Sep. 25, 2008

(30) Foreign Application Priority Data
Aug. 1, 2005 (JP) 2005-222795

(51) Int. Cl. B60Q 1/00

(52) U.S. Cl. 340/436

(57) ABSTRACT

A bumper sensor able to obtain a grasp of a change of shape of a bumper in two dimensions or three dimensions, able to sense a size etc. of a contacting object, and able to be made simple in system configuration is provided. A plurality of optical fibers (20a, 20b) having sensor portions are provided in a surface layer portion or on the front surface of a bumper body 10 for an automobile vehicle, each optical fiber is consisted of a core and a cladding provided on an outer circumference of the core, sensor portions enabling interaction of a portion of transmitted light with the external environment are two-dimensionally arranged at a plurality of positions on a surface forming the front surface of the bumper body, and provision is further made of a light source 11 for emitting incident light to incident ends of optical fibers, and a light receiving portion 13 for detecting beams emitted from emitting ends of optical fibers via sensor portions.

### TECHNICAL FIELD

The present invention relates to a bumper sensor, more particularly relates to a sensor provided at a bumper for sensing deformation etc. of the bumper occurring by a shock with respect to an automobile vehicle.

### BACKGROUND ART

An optical fiber sensor for example has the characterizing feature that it may be embedded. By making good use of this characterizing feature, a method of measurement using an optical fiber sensor for monitoring structural soundness of a composite material is being developed.

A method using the optical fiber sensor as described above to detect deformation etc. occurring in a bumper due to shock with respect to the bumper of an automobile vehicle is being developed.

Japanese Patent Publication (A) No. 7-190732 discloses a bumper sensor providing light leaking fibers in the entirety of the vehicle, providing a light projection unit for emitting light to first ends of these leaking fibers, providing a light receiving unit at the other ends, and sensing collision of the vehicle.

When a collision of the vehicle occurs, fiber transmission paths are broken, compressed, or deformed. Therefore, the amounts of leakage of the fibers change. This can be sensed by the light receiving unit.

However, the bumper sensor disclosed in Japanese Patent Publication (A) No. 7-190732 only senses a collision by breakage of the fiber transmission paths or an increase of the leakage amounts and cannot sense a change in the two-dimensional or three-dimensional shape of the bumper.

Further, Japanese Patent Publication (A) No. 2004-322760 discloses a colliding object discriminating apparatus provided with optical fibers to the bumper of a vehicle, sending modulated light having a predetermined frequency from a laser diode (LD) to the optical fibers as an incident light, and detecting a phase difference from emitted light which passes through the optical fibers and is received at photodiodes (PD) as a vector voltage signal by a vector voltmeter and thereby able to sense a type of colliding object.

Along with the deformation of the bumper due to the collision of the vehicle and the colliding object, the time required for the vector voltage signal to reach a threshold from a trigger level is counted in accordance with an amount of extension or shrinkage occurring in the optical fiber, a target adapted to this required time is extracted from a target discrimination table established in advance, and the target is thereby discriminated.

However, in the colliding object discrimination apparatus disclosed in Japanese Patent Publication (A) No. 2004-322760, in order to discriminate the target, attention is paid to the point that the deformation rate differs when objects having different hardnesses collide with the vehicle. The deformation rate of the bumper is calculated by using the optical fiber. For this purpose, in order to measure a traveling speed at the time of the collision and the required time, it is necessary to detect the phase difference of the incident light/emitted light of the optical fiber. Therefore, there arises a problem that a light receiving portion, vector voltmeter, data processing portion, speedometer, etc. become necessary, so the system becomes troublesome.

Further, concerning the optical fiber sensor described above, a configuration using a so-called hetero core portion as the sensor is disclosed in a pamphlet of International Publication No. 97/48994 and Japanese Patent Publication No. 2003-214906.

However, with the use of the configuration disclosed in the pamphlet of International Publication No. 97/48994 and Japanese Patent Publication No. 2003-214906, a shape etc. of the three-dimensional object cannot be measured.

### DISCLOSURE OF THE INVENTION

### Problem to be Solved by the Invention

The problem to be solved resides in the point that sensing a change in two-dimensional or three-dimensional shape of a bumper and discrimination of an object colliding with a bumper by a simple configuration are difficult.

### Means for Solving the Problems

A bumper sensor of the present invention has a bumper body for an automobile vehicle; a plurality of optical fibers consisted of cores and claddings provided on outer circumferences of the cores, having sensor portions for enabling interaction of portions of transmitted light with the external environment, and being provided so that the sensor portions are arranged at a plurality of positions on a surface forming the front surface of the bumper body and/or inside the bumper body by being buried in a surface layer portion of the bumper body or being provided on the front surface and/or being buried inside the bumper body; a light source for emitting incident light to incident ends of the optical fibers; and a light receiving portion for detecting lights emitted from emitting ends of the optical fibers via the sensor portions.

In the above bumper sensor of the present invention, a plurality of optical fibers consisted of cores and claddings provided on the outer circumferences of the cores and having sensor portions are arranged at the surface layer portion or front surface and/or inside of the bumper body for the automobile vehicle, and a plurality of sensor portions enabling interaction of a portion of the transmitted light with the external environment are arranged at a plurality of positions on the surface forming the front surface of the bumper body and/or inside the bumper body.

Further, provision is made of a light source for emitting incident light with respect to incident ends of optical fibers and a light receiving portion for detecting light emitted from emitting ends of optical fibers via the sensor portions.

The above bumper sensor of the present invention preferably is configured wherein each sensor portion is a hetero core portion having a core diameter different from the core diameter of an optical fiber and is joined to a middle portion of the optical fiber.

Alternatively, preferably, each sensor portion is configured by an optical transparent material having a refractive index equivalent to the refractive index of the core of the optical fiber or the refractive index of the cladding joined to the middle portion of the optical fiber.

In the above bumper sensor of the present invention, preferably the sensor portions are arranged two-dimensionally or three-dimensionally at a plurality of positions on a plurality of curves or planes forming the surface of the bumper body.

In the above bumper sensor of the present invention, preferably the optical fibers form a first system arranged along a first direction on a surface forming the front surface of the bumper body and a second system arranged along a second direction different from the first direction.

Further, preferably the optical fibers are arranged along three or more directions on a surface forming the front surface of the bumper body.

In the above bumper sensor of the present invention, preferably the sensor portions have a first region where they are arranged with a first density at a surface constituting the front surface of the bumper body and a second region where they are arranged with a second density different from the first density.

The above bumper sensor of the present invention preferably further has an optical switch unit for branching the light from the light source to a plurality of beams and making the beams incident upon the plurality of optical fibers while switching them or an optical branch unit for making the beams incident upon the plurality of optical fibers.

Further, preferably the light receiving portion is a array of light receiving elements for sequentially or simultaneously measuring beams emitted from emitting ends of the plurality of optical fibers.

Furthermore, preferably the sensor portion senses a shape change of the bumper body.

### EFFECT OF THE INVENTION

The bumper sensor of the present invention can use sensor portions having hetero core structures provided in optical fibers to quickly sense contact of an object with the bumper, can superimpose optical fibers and laying sensor portions at many points so as to obtain a grasp of the shape of the bumper and the change thereof in two dimensions or three dimensions, can sense a size etc. of the contacting object, and performs processing by only a light intensity, so can constitute an input/output portion by a combination of a light emitting element and a light receiving element and can be made a simple system configuration.

### BRIEF DESCRIPTION OF THE DRAWINGS

FIG. 1A is a schematic diagram of an automobile vehicle provided with a bumper sensor according to an embodiment of the present invention, and FIG. 1B is a schematic diagram showing the configuration of the bumper sensor according to the embodiment of the present invention.

FIG. 2A is a perspective view of the vicinity of a sensor portion SP of an optical fiber for showing an example of the configuration of the sensor portion, and FIG. 2B is a sectional view in a longitudinal direction of the vicinity of the sensor portion.

FIG. 3A and FIG. 3B are sectional views in the longitudinal direction of the vicinity of sensor portions of optical fibers for showing an example of the configuration of the sensor portion.

FIG. 4A and FIG. 4B are schematic diagrams showing layouts of optical fibers and sensor portions in a case where a plurality of systems are provided according to the embodiment of the present invention.

FIG. 5A and FIG. 5B are schematic diagrams showing a layout of optical fibers and sensor portions in a case where systems extending in three or more directions are provided according to the embodiment of the present invention.

FIG. 6A and FIG. 6B are schematic diagrams showing layouts of a first region and second region having different densities of arrangement of sensor portions according to the embodiment of the present invention.

### DESCRIPTION OF NOTATIONS

3 . . . hetero core portion, 4 . . . interface, 10 . . . bumper body, 11 . . . light source, 12 . . . optical switch unit or optical branch unit, 13 . . . light receiving portion, 14 . . . signal processing portion, 20a, 20b . . . optical fibers, 21, 31 . . . cores, 22, 32 . . . claddings, 30 . . . optical transparent material, A . . . automobile vehicle body, B . . . bumper, SP . . . sensor portion, DR . . . extension direction, DRₓ . . . first direction, DR_{y} . . . second direction, DR_{α} . . . third direction, DR_{β} . . . fourth direction, and W . . . leakage light.

### BEST MODE FOR CARRYING OUT THE INVENTION

Below, embodiments of a bumper sensor of the present invention will be explained with reference to the drawings.

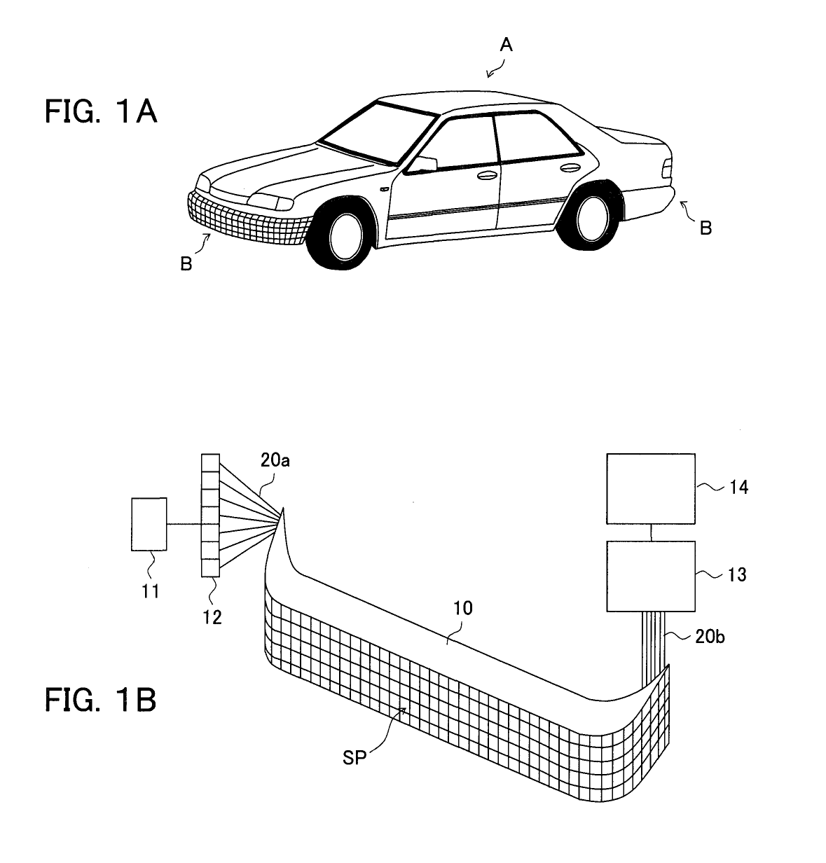

FIG. 1A is a schematic diagram of an automobile vehicle provided with a bumper sensor according to the present embodiment. Bumpers B are provided at a front portion and a rear portion of an automobile vehicle body A.

FIG. 1B is a schematic diagram showing the configuration of the above bumper sensor.

In the bumper sensor according to the present embodiment, a plurality of optical fibers (20a, 20b) consisted of cores and with claddings provided on the outer circumference of the cores are buried in a surface portion of a bumper body 10 or provided on the front surface and/or buried inside of the bumper body. The optical fibers (20a, 20b) are for example single mode fibers having core diameters of for example 9 μm.

Between the optical fibers 20a and optical fibers 20b, sensor portions SP enabling interaction of a portion of the transmitted light with the external environment are provided. These sensor portions SP are arranged for example one-dimensionally, two-dimensionally, or three-dimensionally at a plurality of positions on the surface forming the front surface of the bumper body 10 and/or inside the bumper body 10, which is made of polyurethane foam or other flexible material and shaped into a bumper.

Further, the sensor has a light source 11 such as a light emitting diode (LED) or laser diode (LD) for emitting incident light to incident ends of the optical fibers. Light coupling of the single light source 11 and the plurality of optical fibers is carried out by for example an optical switch unit (optical switch) or optical branch unit (light coupler) 12. The optical switch unit branches the light from the light source 11 into a plurality of beams and makes these incident on the plurality of optical fibers 20a while switching them. The optical branch unit branches the light from the light source 11 into a plurality of beams and makes these incident upon the plurality of optical fibers.

Further, the sensor has a light receiving portion 13 for detecting light emitted from emitting ends of the optical fibers 20b via the sensor portions SP. The light receiving portion 13 is preferably an array of light receiving elements such as line sensors made of for example photodiodes and sequentially or simultaneously measures light emitted from emitting ends of the plurality of optical fibers 20b.

Further, the bumper sensor according to the present embodiment has a signal processing portion 14.

The signal processing portion 14 performs current-to-voltage conversion or other signal processing with respect to the optical signal output from the light receiving portion 13, generates image data and other predetermined data, and performs signal processing required for the obtained data and thereby is able to sense the deformation of the surface of the bumper, pressure from the external environment, etc. Further, it outputs the data from a not shown output port to an image display portion etc.

The optical fibers (20a, 20b) have sensor portions SP at their middle portions, that is, between the optical fibers 20a on the light incident side and the optical fibers 20b on the light emitting side.

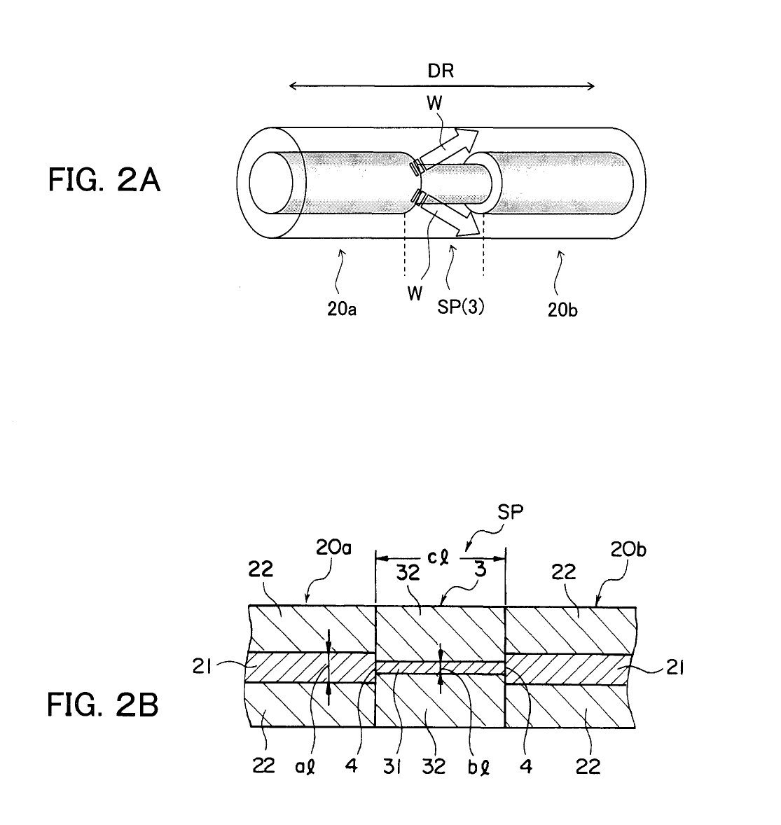

FIG. 2A is a perspective view of the vicinity of a sensor portion SP of optical fibers (20a, 20b) for showing an example of the configuration of the sensor portion SP, and FIG. 2B is a sectional view in the longitudinal direction of the vicinity of the sensor portion SP.

The optical fibers (20a, 20b) have cores 21 and claddings 22 provided on their outer circumferences. The light from the optical switch unit or optical branch unit 12 is made to incident the core 21 from the light incident end side and is emitted from the core 21 on the light emitting end side to the light receiving portion via the sensor portion SP.

The sensor portion SP shown in FIG. 2A and FIG. 2B is a hetero core portion 3 having a core diameter different from the core diameter of the optical fibers (20a, 20b) and has a core 31 and cladding 32 provided on its outer circumference.

A diameter b1 of the core 31 in the hetero core portion 3 is smaller than a diameter a1 of the cores 21 of the optical fibers (20a, 20b). For example a1=9 μm, and b1=5 μm. Further, a length c1 of the hetero core portion 3 is a few millimeters to a few centimeters and for example about 1 mm.

The optical fibers (20a, 20b) and the hetero core portion 3 constituting the sensor portion SP are substantially coaxially joined so that cores are joined to each other at interfaces 4 perpendicular to the longitudinal direction by for example the common technique of fusion splicing by electrodischarge.

As shown in FIG. 2A and FIG. 2B, in a configuration were the sensor portion SP is joined to the middle portion of the optical fibers (20a, 20b), the diameter b1 of the core 31 in the hetero core portion 3 and the diameter a1 of the core 21 of the optical fiber (20a, 20b) are different at the interface 4. A portion of the light W is leaked to the cladding 32 of the hetero core portion 3 due to this difference of core diameters. When the combination of diameters of the core 21 and core 31 is selected so as to reduce the leakage W, most of the light is incident upon the optical fiber 21 again and transmitted. At this time, an insertion loss of the sensor is small, and a degree of the leakage W sharply changes according to bending or other external environment change. Further, according to some combinations of diameters of the core 21 and core 31, the leakage W can be made extremely large as well. In this case, the many lights of leakage W generate evanescent waves at the interfaces between the cladding 32 and the external environment. These waves act upon the external environment, and enable changes to be picked up.

The light leaked as described above changes in accordance with the degree of bending of the optical fibers in the sensor portion SP. Therefore, by sensing change occurring as a result of interaction with the external environment and by arranging sensor portions SP at a plurality of positions, a pressure distribution from the external environment, shape of the bumper body 10, and a change of these can be sensed. Namely, when distortion or other fluctuation is given to the hetero core portion or other SP portion, the light entering in the hetero core portion is leaked to the cladding, and a loss (change) occurs in the amount of the light received at the light receiving portion. By detecting this, the distortion etc. of the bumper body 10 can be detected. For example, as shown in FIG. 2A, the pressure distribution from the external environment of the bumper body 10 along the extension direction DR of the optical fibers (20a, 20b), shape, and the change of these are detected.

As the sensor portion SP, other configurations can be employed as well.

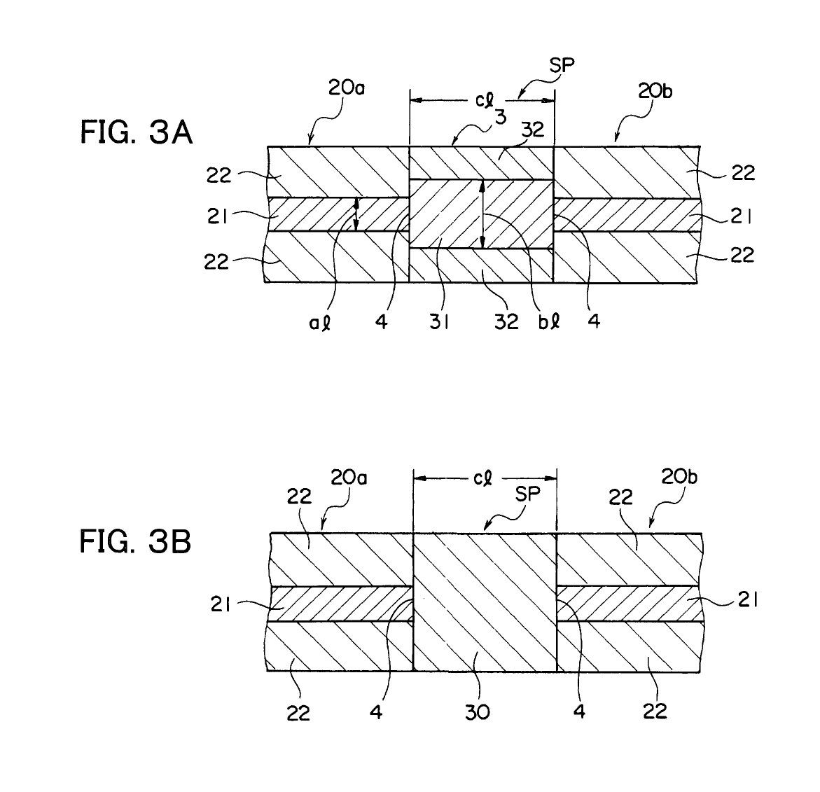

FIG. 3A and FIG. 3B are sectional views in the longitudinal direction of the vicinity of sensor portions SP of optical fibers (20a, 20b) for showing an example of the configuration of sensor portions SP.

In FIG. 3A, the diameter b1 of the core 31 of the hetero core portion 3 constituting the sensor portion SP becomes larger than the diameter a1 of the cores 21 of the optical fibers (20a, 20b) in this configuration.

As shown in FIG. 3B, in place of the hetero core portion, the sensor portion SP can be constituted so that an optical transparent material 30 having a refractive index equivalent to the refractive index of the core 21 of the optical fiber (20a, 20b) or the refractive index of the cladding 22 is joined to the middle portion of the optical fibers (20a, 20b) as well.

In the bumper sensor in the present embodiment, when pressure is applied by the colliding object from the external environment, and the surface of the bumper body deforms, optical fibers having sensor portions arranged at a plurality of positions deform as well.

Here, as described above, by making light from the light source 11 incident upon the optical fibers 20a, emitting light interacting with the external environment at the sensor portions SP from the optical fibers 20b, receiving these at the light receiving portion 13, processing optical signals output from the light receiving portion 13 at the signal processing portion 14, forming image data and other data, and performing the required signal processing for the obtained data, the deformation of the surface of the bumper, pressure from the external environment, etc. can be sensed. Further, the data may be output from a not shown output port to the image display portion etc. as well.

In the bumper sensor according to the present embodiment, sensor portions SP are preferably arranged at a plurality of positions in a two-dimensional or three-dimensional manner on a plurality of curves or planes forming the front surface of the bumper body 10.

For example, the surface of a bumper having a predetermined three-dimensional shape is constituted by a variety of planes and curves. By analyzing the deformation on these plurality of surfaces, the pressure from the external environment etc. and the shape of the overall bumper body and its change can be grasped in more detail in the two dimensions or three dimensions, and it becomes possible to sense the size etc. of the colliding object.

Further, the optical fibers (20a, 20b) provided with the sensor portion in the middle portion as described above can detect the pressure distribution from the external environment of the bumper body 10 along the extension direction DR of the optical fibers (20a, 20b), the shape, and a change of these, but sometimes the pressure distribution along a direction different from this and the shape change etc. cannot be detected.

Therefore, the optical fibers preferably include a first system arranged along a first direction on a surface forming the front surface of the bumper body and second system arranged along a second direction different from the first direction.

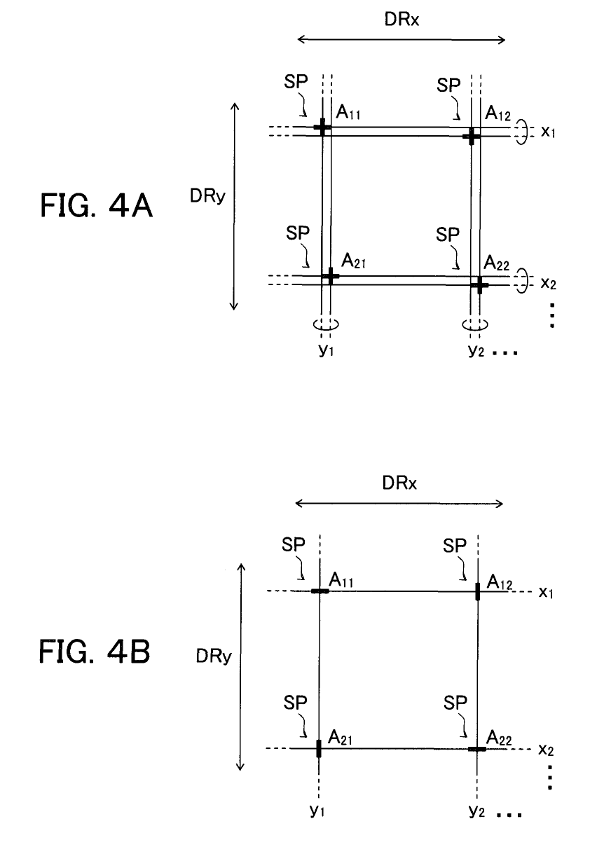

FIG. 4A and FIG. 4B are schematic diagrams showing a layout of optical fibers and sensor portions in a case where the above plurality of systems are provided.

FIG. 4A shows a configuration where a first system (x₁, x₂, . . . ) extending in a first direction DP, and a second system (y₁, y₂, . . . ) extending in a second direction DR_{y} schematically perpendicular to the first direction DRₓ are provided. Both of the first system and second system are provided with sensor portions at each of the positions (A₁₁, A₁₂, A₂₁, A₂₂, . . . ) where these systems intersect.

Further, FIG. 4B shows a configuration where a schematically intersecting first system (x₁, x₂, . . . ) and second system (y₁, y₂, . . . ) are provided, and the first system and second system are alternately provided with sensor portions SP at positions (A₁₁, A₁₂, A₂₁, A₂₂, . . . ) where these systems intersect. Namely, for example, the sensor portions are provided in optical fibers of the first system at positions (A₁₁, A₂₂, . . . ) and the sensor portions are provided in optical fibers of the second system at positions (A₁₂, A₂₁, . . . ).

Further, the sensor portions may be provided along a pattern other than the above patterns as well.

Note that FIG. 1B shows a configuration having a first system and a second system schematically perpendicular to this as well, but illustration of the optical fibers (20a, 20b) etc. is provided for only one system and is omitted for the other side system.

As described above, by providing a first system having optical fibers arranged along a first direction and a second system having optical fibers arranged along a second direction different from the first direction, the pressure distribution along a plurality of directions, shape change, etc. can be detected, the shape of the bumper and its change can be grasped more precisely in two dimensions or three dimensions, and the size etc. of the contacting object can be sensed.

Further, the optical fibers are preferably arranged on the surface forming the front surface of the bumper body along three or more different directions.

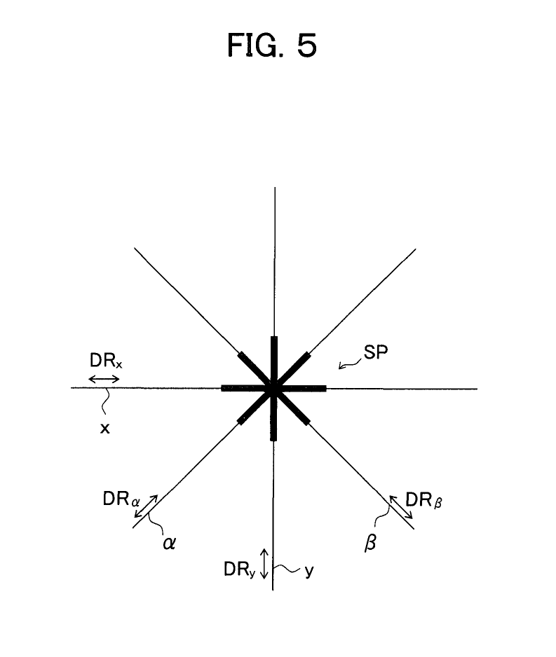

FIG. 5 is a schematic diagram showing a layout of optical fibers and sensor portions in a case where optical fibers are arranged along three of more different directions (four directions in the drawing) as described above.

FIG. 5 shows a configuration where a first system (x . . . ) extending in a first direction DRₓ, a second system (y . . . ) extending in a second direction DR_{y} schematically perpendicular to the first direction DRₓ, a third system (α . . . ) extending in a third direction DR_{α} intersecting with the first direction DRₓ and second direction DR_{y} at angle of 45°, and a fourth system (β . . . ) extending in a fourth direction DR_{β} intersecting with the second direction DR_{y}, schematically perpendicular to the first direction DRₓ at the angle of 45°, and perpendicular to the third direction DR_{α} are provided. At positions (A . . . ) where these systems intersect, sensor portions SP are provided in all of the first system, second system, third system, and fourth system. In this configuration, by analyzing the signals of the first system, second system, third system, and fourth system, it is possible to grasp the deformation of the bumper with respect to each of the first to fourth directions at positions where sensors are provided.

Preferably, sensor portions having the configuration for example as described above are provided over the entire front surface of the bumper body.

Alternatively, sensor portions may be arranged on the front surface of the bumper body so that sensors of the above first system, second system, third system, and fourth system are not superimposed.

As described above, by the arrangement of optical fibers along three of more different directions, the pressure distribution, shape change etc. along each of the three or more directions in which optical fibers are arranged can be detected, the shape of the bumper and its change can be more precisely grasped in two dimensions or three dimensions, and the size etc. of the contacting object can be sensed.

Further, the sensor portions preferably have a first region where they are arranged with a first density on the surface forming the front surface of the bumper body and a second region where they are arranged with a second density different from the first density.

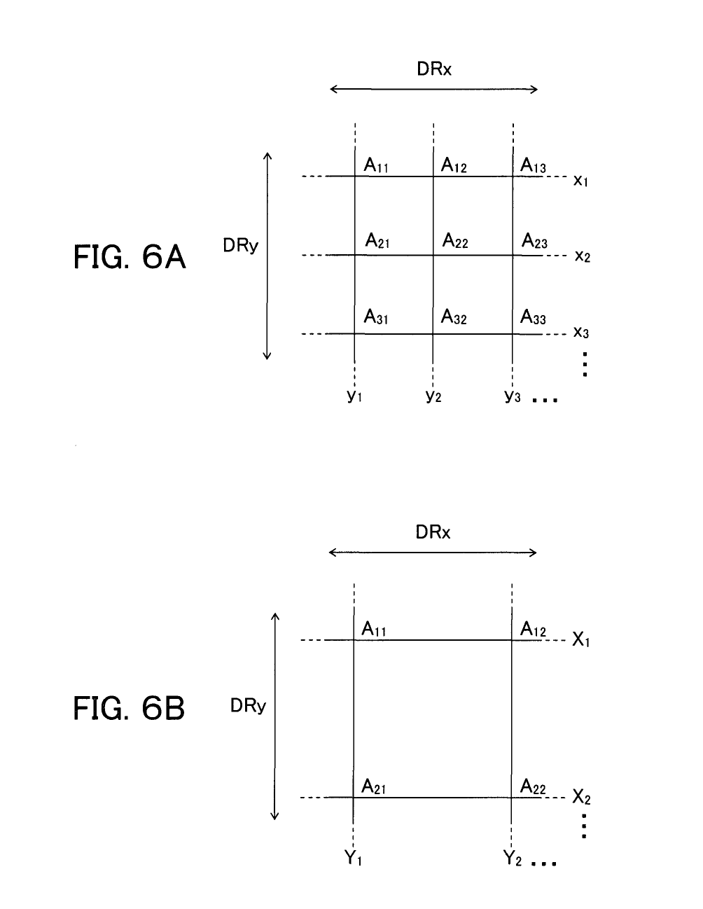

FIG. 6A and FIG. 6B are schematic diagrams showing layouts of the first region and second region having different densities of arrangement of sensor portions described above.

FIG. 6A shows a configuration wherein a first region is provided with a first system (x₁, x₂, . . . ) extending in a first direction DRₓ and a second system (y₁, y₂, . . . ) extending in a second direction DR_{y} schematically perpendicular to the first direction DRₓ and provided with sensor portions SP with a first density at the positions (A₁₁, A₁₂, A₂₁, A₂₂, . . . ) where these systems intersect. FIG. 6B shows a configuration wherein a second region is provided with a first system (X₁, X₂, . . . ) extending in a first direction DRₓ and a second system (Y₁, Y₂, . . . ) extending in a second direction DR_{y} schematically perpendicular to the first direction DRₓ and provided with sensor portions SP with a second density lower than the first density.

Further, sensor portions may be provided along patterns that continuously change in density as well.

As described above, by providing a first region having sensor portions arranged with the first density and a second region having sensor portions arranged with the second density different from the first density, sensor portions can be provided with a high density in an area where a structural change of the bumper is apt to occur and having a high importance, while sensor portions can be provided with a low density in an area where a structural change is hard to occur and having a low importance, whereby necessary data can be acquired more efficiently.

According to the bumper sensor of the present embodiment, distribution of loss (change) of light in sensor portions can be measured in real time in the sensor portions distributed to a plurality of positions. Therefore, the shape of bumper, the deformation thereof, and damage state etc. can be monitored in real time.

Further, by arranging optical fiber sensors on the front surface or inside of the bumper two-dimensionally with angles, the size of the object contacting the bumper and a deformation direction given to the bumper after that and a deformation amount can be simultaneously sensed.

Further, it is possible to sense the size of the object contacting the bumper and the deformation direction and the deformation amount given to the bumper after that as described above and, when the shock is a predetermined value or more, initiate an operation to secure the safety of the driver/passengers of the automobile vehicle. For example, airbags can be deployed.

According to the bumper sensor of the present embodiment described above, by the combination of the light emitting element and light receiving elements for measurement, the measurement can be carried out by only the light intensity without dealing with wavelength dependency, polarization, etc., therefore the measurement system becomes simple and cheap.

Further, as the light source, use can be made of an inexpensive laser diode or light emitting diode and other light emitting element. As the light receiving portion as well, used can be made of inexpensive photodiodes etc. Further, the sensor portion can be easily formed by fusion splicing etc. as well. Therefore, a convenient and inexpensive system can be constructed.

Further, a hetero core type optical fiber sensor is a sensor using a single mode fiber, therefore stable measurement without taking reference light is possible. For this reason, even when optical fibers are two-dimensionally or three-dimensionally arranged, the number of optical fiber lines becomes only the number of sensors, and the load of the trouble of light receiving elements can be reduced as well.

Further, optical fibers having flexible characteristics are used, therefore these can be suitably laid on the front surface of a bumper having a variety of planes and curves as well.

The present invention is not limited to the above explanation.

For example, in the above embodiment, the sensor portions are laid on the front surface of the bumper in the drawings. However, other than this, a configuration providing sensor portions buried inside the bumper body can be employed as well.

Other than these, various modifications are possible within a range not out of the gist of the present invention.

### INDUSTRIAL APPLICABILITY

The bumper sensor of the present invention can be applied as the bumper of an automobile vehicle able to discriminate a target giving a shock.

1. A bumper sensor having:
a bumper body for an automobile vehicle;
a plurality of optical fibers consisted of cores and claddings provided on outer circumferences of the cores, having sensor portions for enabling interaction of portions of transmitted light with the external environment, and being provided so that the sensor portions are arranged at a plurality of positions on a surface forming the front surface of the bumper body and/or inside the bumper body by being buried in a surface layer portion of the bumper body or being provided on the front surface and/or being buried inside said bumper body;
a light source for emitting incident light to incident ends of the optical fibers; and
a light receiving portion for detecting lights emitted from emitting ends of the optical fibers via the sensor portions.

2. A bumper sensor as set forth in claim 1, wherein each sensor portion is a hetero core portion having a core diameter different from the core diameter of an optical fiber and is joined to a middle portion of the optical fiber.

3. A bumper sensor as set forth in claim 1, wherein each sensor portion is configured by an optical transparent material having a refractive index equivalent to the refractive index of the core of the optical fiber or the refractive index of the cladding joined to the middle portion of the optical fiber.

4. A bumper sensor as set forth in any one of claims 1 to 3, wherein the sensor portions are arranged two-dimensionally or three-dimensionally at a plurality of positions on a plurality of curves or planes forming the surface of the bumper body.

5. A bumper sensor as set forth in any one of claims 1 to 3, wherein the optical fibers form a first system arranged along a first direction on a surface forming the front surface of the bumper body and a second system arranged along a second direction different from the first direction.

6. A bumper sensor as set forth in any one of claims 1 to 3, wherein the optical fibers are arranged along three or more directions on a surface forming the front surface of the bumper body.

7. A bumper sensor as set forth in any one of claims 1 to 3, wherein the sensor portions have a first region where they are arranged with a first density at a surface constituting the front surface of the bumper body and a second region where they are arranged with a second density different from the first density.

8. A bumper sensor as set forth in any one of claims 1 to 3, further having an optical switch unit for branching the light from the light source to a plurality of beams and making the beams incident upon the plurality of optical fibers while switching them or an optical branch unit for making the beams incident upon the plurality of optical fibers.

9. A bumper sensor as set forth in any one of claims 1 to 3, wherein the light receiving portion is an array of light receiving elements for sequentially or simultaneously measuring beams emitted from emitting ends of the plurality of optical fibers.

10. A bumper sensor as set forth in any one of claims 1 to 3, wherein the sensor portion senses a shape change of the bumper body.
